(19) United States
(12) Patent Application Publication
(10) Pub. No.: US 2003/0048378 A1
(43) Pub. Date: Mar. 13, 2003

(54) Imaging device module package

(75) Inventors: Young Jun Kim, Sungnam-Shi (KR); Dae Yung Yun, Seoul (KR)

Correspondence Address: DARBY & DARBY P.C., 805 Third Avenue, New York, NY, 10022, US

(73) Assignee: SAMSUNG ELECTRO-MECHANICS CO., LTD., Suwon-Shi (KR)

(21) Appl. No.: 09/988,917

(22) Filed: Nov. 19, 2001

(30) Foreign Application Priority Data
Sep. 11, 2001 (KR) 2001-55708

(51) Int. Cl. H04N 5/225

(52) U.S. Cl. 348/375

(57) ABSTRACT

Disclosed is an imaging device package, in particular, comprising: a circuit board electrically connected to an image sensor chip through wire bonding; a housing adhered to the circuit board except for an area wire bonded with the sensor chip and having an opening at the top and steps with rounded sides around the opening; and a holder at the bottom having a ring-shaped opening corresponding to the steps around the opening of the housing for interference fitting around the steps and an lens internally fitted to the holder.

### BACKGROUND OF THE INVENTION

1. Field of the Invention

The present invention relates to an imaging device package, and more particularly, to an imaging device module package, in which a housing for forming the package is provided with steps, by which a holder coupled with a lens is settled on the previously formed steps to improve dual structure and assembling ability, and by which productivity is enhanced through improving workability of an IR filter and simultaneous processing of the housing and the IR filter while cost saving and airtightness can be expected through reducing the thickness of the housing.

2. Description of the Related Art

In general, an imaging device is provided to recognize images in a video camera, an electronic still camera, a PC camera, a terminal, a Personal Digital Assistant (PDA), and etc. An imaging module has a process of manufacture as follows in reference to FIGS. 1 to 6. First, a number of image sensor chips are separated by the piece through a semiconductor manufacturing process as shown in FIG. 1. In this case, the each image chip sensor 51 has an image area 52 that can substantially detect an image.

Then, as shown in FIG. 2, the image sensor chip 51 is die bonded on a circuit board 50 after separated by the piece through the process shown in FIG. 1. When the image sensor chip is die bonded on the circuit board 50 through the process shown in FIG. 2, a wire bonding is carried out using a wire 53 for electrical connection between the image sensor chip 51 and the circuit board 50 as shown in FIG. 3.

When the wire bonding is finished as shown in FIG. 3, a housing 10 having a cover glass or an IR filter 30 being adhered thereto via a synthetic resin 40, i.e. an epoxy, as shown in FIG. 4, is adhered on the circuit board 50 having the image sensor chip 51 being wire-bonded thereto by also using the synthetic resin 40, as shown in FIG. 5, to keep the imaging device module airtight.

Then, as shown in FIG. 6, a holder 20 having a lens is settled on or screwed into an opening of the housing 10.

Considering the module package structure of the imaging device which is finally assembled in reference to FIG. 6, the module package comprises the housing 10 provided with a space 11 therein.

The holder 20 is inserted into one end of the housing 10, and internally fitted with a lens 21 for correct focusing of the image.

Meanwhile, on the space 11 of the housing 10 is fixedly adhered the IR filter or iris filter 30 via the synthetic resin 40, and to the end of the housing 10 is fixedly installed the ceramic circuit board 50 via the synthetic resin 40 also.

In the upper surface of the circuit board 50 is provided the image sensor 51.

In this case, the image sensor 51 is installed on the circuit board 50 through wire bonding after die bonding.

The foregoing imaging module package of the prior art has no operational problem, however, is not suitable to be used in the device which becomes gradually smaller and thinner due to basically large volume. Moreover, there is a problem that the yield in manufacturing process is lowered since the holder 20 is necessarily screwed into the opening of the housing 10.

### SUMMARY OF THE INVENTION

Accordingly, the present invention has been made to solve the foregoing problems of the prior art and it is an object of the invention to provide an imaging device module package, in which a housing for forming the package is provided with steps, by which a holder coupled with a lens is settled on the previously formed steps to improve dual structure and assembling ability, and by which productivity is enhanced through improving workability of an IR filter and simultaneous processing of the housing and the IR filter while cost saving and airtightness can be expected through reducing the thickness of the housing.

According to an embodiment of the invention to obtain the foregoing object, it is provided an imaging device module package comprising: an image sensor chip for reading an image; a circuit board electrically connected to the image sensor chip; a housing adhered on the circuit board, and having an opening at the top for allowing light to the imaging sensor chip and steps with rounded sides around the opening; and a holder having a ring-shaped opening corresponding to the steps around the opening of the housing for interference fitting around the steps and an lens internally fitted to the holder.

According to the embodiment of the invention to obtain the foregoing object, the imaging device module package further comprises a projection in an inner side of the housing for settling an iris filter or a cover glass, and a projection in an inner side of the holder for settling the lens, the projection face contacting with the opening of the housing.

### BRIEF DESCRIPTION OF THE DRAWINGS

The above objects, features and advantages of the present invention will become more apparent from the following detailed description when taken in conjunction with the accompanying drawings, in which:

FIGS. 1 to 6 illustrate a manufacturing process of an imaging device module package of the prior art; and

FIGS. 7 to 9 illustrate a structure of an imaging device module package of the invention.

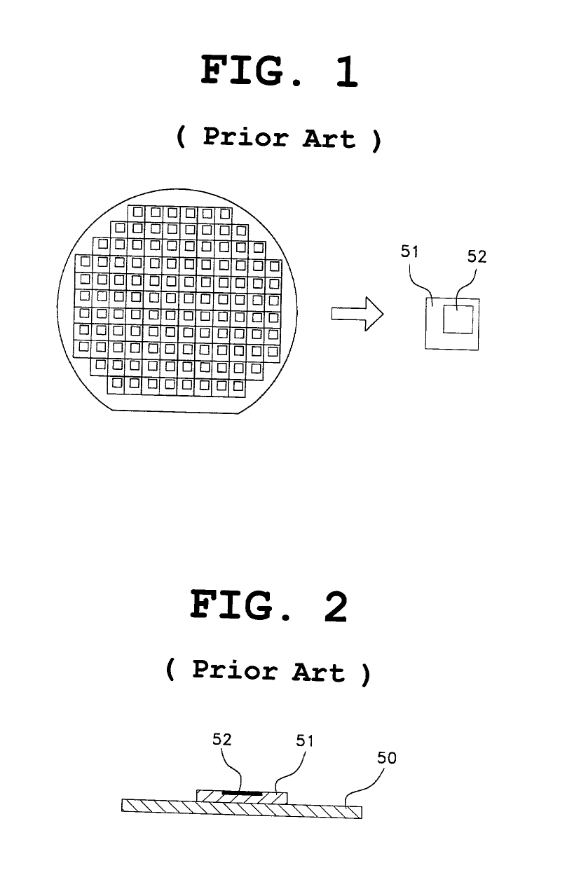

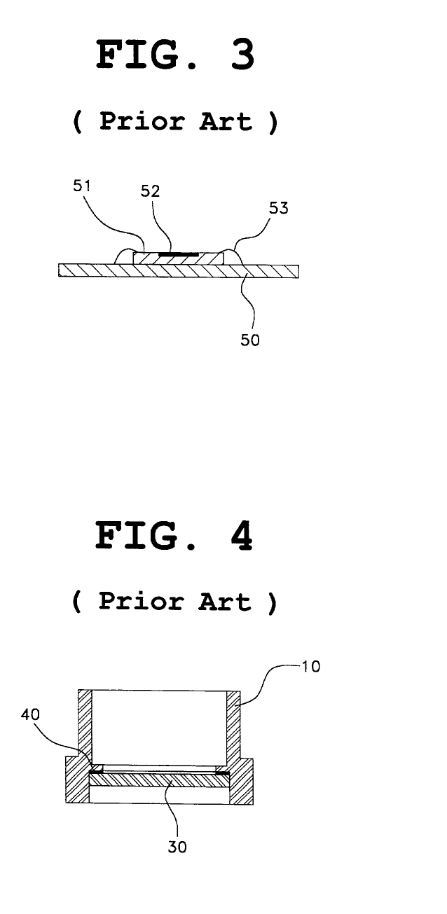

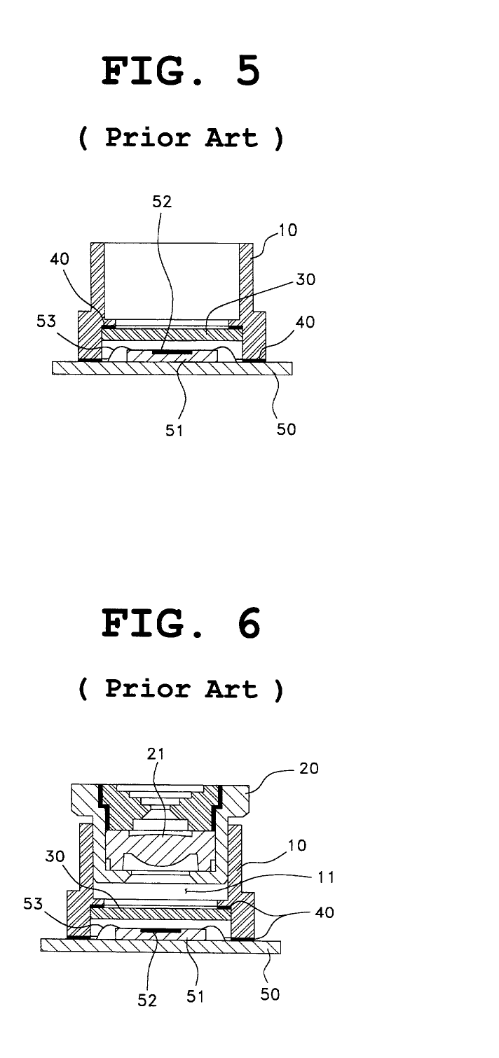

### DETAILED DESCRIPTION OF THE PREFERRED EMBODIMENT

The foregoing objects and various advantages of the invention will be more apparent by those skilled in the art from a preferred embodiment of the invention described hereinafter in reference to the accompanying drawings.

Hereinafter detailed description will be made about the preferred embodiment of the invention in reference to the accompanying drawings.

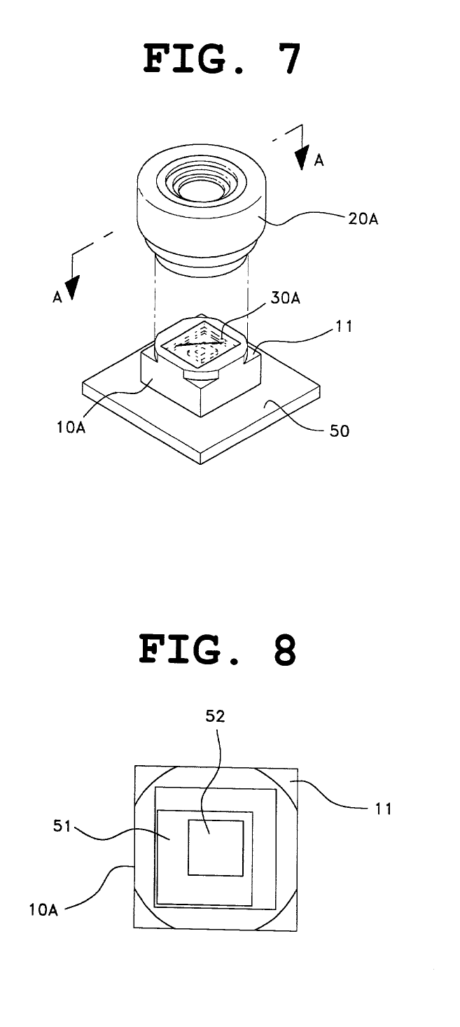

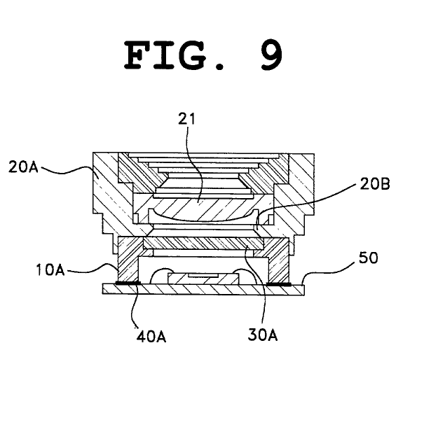

FIGS. 7 to 9 illustrate a structure of an imaging device module package according to the invention, in which FIG. 7 is a perspective assembly view for showing a holder is coupled to a housing adhered to a circuit board according to the invention, FIG. 8 is a plan view of the housing adhered to the circuit board shown in FIG. 7 of the invention, and FIG. 9 illustrates an A-A section of the imaging device module package shown in FIG. 7 finished in assembly of the invention.

Referring to FIG. 8, a housing 10A has steps designated with the reference numeral 11 with rounded sides around an opening (having no reference numeral).

Therefore, a round opening (not shown) in the lower part of a holder designated with the reference numeral 20A having a lens is interference fit around the steps 11 formed around the opening of the housing 10A.

This causes an IR filter or a cover glass designated with the reference numeral 30A to be settled around the opening of the housing and be fixed without play even if a particular fixing means is not used as the holder 20A is interference fit around the steps 11 formed around the opening of the housing 10A.

FIG. 9 illustrates the A-A section of the imaging device module package which is finally assembled according to the perspective assembly view show in FIG. 7, in which the steps of the invention are concealed and thus not shown in FIG. 9.

As shown in FIG. 9, a lens settling portion 20B projected from an inner side of the holder 20A is engaged into the opening of the housing 10A to fix the IR filter or the cover glass 30A so that the lens 21 can be settled on the holder 20A without using an adhering means such as synthetic resin.

Also, the circuit board includes a flexible circuit board.

According to the imaging device module package of the invention as described hereinbefore, the holder housing is covered over the conventional package module to settle the holder on the previously formed steps thereby enhancing dual structure and ability of assembly. Productivity is enhanced through improving workability of the IR filter and simultaneous processing of the housing and the IR filter while cost saving and airtightness can be expected through reducing the thickness of the housing.

While the invention has been shown and described in reference to specific embodiment in the foregoing description, it will be apparent to those skilled in the art that various modification and variations can be made without departing from the principle and scope of the invention defined in the following claims.

What is claimed is:

1. An imaging device module package comprising:
an image sensor chip for reading an image;
a circuit board electrically connected to said image sensor chip;
a housing adhered on said circuit board, and having an opening at the top for allowing light to said imaging sensor chip and steps with rounded sides around said opening; and
a holder having a ring-shaped opening corresponding to said steps around said opening of the housing for interference fitting around said steps and an lens internally fitted to said holder.

2. The imaging device module package according to claim 1, further comprising a projection in an inner side of said housing for settling an iris filter or a cover glass.

3. The imaging device module package according to claim 1, further comprising a projection in an inner side of said holder for settling said lens, said projection face contacting with said opening of the housing.

4. The imaging device module package according to claim 1, wherein said circuit board is a flexible circuit board.
